(19) United States
(12) Patent Application Publication
(10) Pub. No.: US 2025/0382833 A1
(43) Pub. Date: Dec. 18, 2025

(54) MOTOR VEHICLE COMPRISING AN ARRANGEMENT FOR UNLOCKING A LOCK OF A FRONT HOOD

(71) Applicant: AMPERE S.A.S., Boulogne Billancourt (FR)

(72) Inventors: Luc ADRI, Guyancourt (FR); Loïc BEZEAULT, Guyancourt (FR); Lionel GIRARDI, Guyancourt (FR)

(73) Assignee: AMPERE S.A.S., Boulogne Billancourt (FR)

(21) Appl. No.: 18/879,108

(22) PCT Filed: Jun. 19, 2023
(86) PCT No.: PCT/EP2023/066508

§ 371 Date: Feb. 10, 2025

(30) Foreign Application Priority Data
Jul. 6, 2022 (FR) FR2206898

(51) Int. Cl. E05B 83/24; B60L 53/16; E05B 79/20

(52) U.S. Cl. CPC E05B 83/24; B60L 53/16; E05B 79/20; B60Y 2400/411

(57) ABSTRACT

A motor vehicle includes an arrangement for unlocking a lock of a front hood. The arrangement includes a gripping structure and a cable connecting the lock of the front hood to the gripping structure. The gripping structure is accessible to a user from the outside of a passenger compartment of the motor vehicle. The cable is positioned on the outside of the passenger compartment of the motor vehicle.

The invention relates to a motor vehicle comprising an arrangement for unlocking a front hood. The invention also relates to such an arrangement installed in a charging port of an electric vehicle. The invention also relates to a method for unlocking a front hood of such a motor vehicle. The invention likewise relates to a method for charging a vehicle equipped with a charging port comprising an arrangement according to the invention.

In most motor vehicles, opening the front hood of the vehicle requires performing a manipulating operation in the passenger compartment of the vehicle, notably pulling on a cable connected to a lock of the front hood. This technical solution has the advantage of being mechanically simple and securing access to the engine/motor area of the vehicle.

However, nowadays the front hood of a vehicle is opened much more frequently, notably in connection with electric vehicles. This is because, owing to the smaller size of their motor, some electric vehicles can have a fitting which is underneath the front hood of the vehicle and can serve as a storage compartment. Such a fitting can notably be used to store cables for connecting the vehicle to a private or public charging terminal. Some of the problems now relate to the ease of accessing such a recess, notably for vehicles which have a charging port which is away from the hood. The user of the vehicle must then move around to various areas of the vehicle, firstly to the passenger compartment to make the hood unlock, then to the hood to collect the charging cables, and then to the charging port to connect the cables to the terminal and to the vehicle.

There are technical solutions that make it easier to open a front hood, such as the unlocking of electric locks via a smartphone or the use of electric actuators to open a front hood lock. However, it is expensive to implement such solutions.

The aim of the invention is to provide an arrangement for unlocking a front hood of a vehicle and a method for unlocking a front hood of a vehicle that overcome the aforementioned drawbacks and improve the hood unlocking arrangements and methods known from the prior art. In particular, the invention makes it possible to realize an arrangement and a method that are simple, inexpensive and reliable and make it possible to securely and more easily open a front hood.

To this end, the invention relates to a motor vehicle comprising an arrangement for unlocking a lock of a front hood, the arrangement comprising a grip means and a cable connecting the lock of the front hood to the grip means, characterized in that the grip means is accessible to a user from outside a passenger compartment of the motor vehicle and in that the cable is positioned outside the passenger compartment of the motor vehicle.

In one embodiment, the grip means is at the front hood or in an area close to the front hood of the motor vehicle, notably at a front fender or a front bumper or a front grille.

In one embodiment, the motor vehicle comprises a security element intended to prevent an unauthorized person from using the grip means.

In one embodiment, the arrangement comprises an authentication means which collaborates with the security element, such that the grip means can be used only when an item for identifying a user is authenticated by the authentication means.

In one embodiment, the motor vehicle is an electric vehicle and the grip means is disposed inside a charging port of the electric vehicle.

In one embodiment, the authentication means interacts with a device for locking the charging port of the motor vehicle, such that it is capable of unlocking the charging port after the identifying item has been authenticated.

In one embodiment, the motor vehicle comprises an identifying item capable of interacting with a device for locking the motor vehicle to allow or not allow access to the passenger compartment of the motor vehicle, and the same identifying item is capable of interacting with the authentication means of said arrangement to unlock the lock of the front hood and/or of said device for locking the charging port of the motor vehicle.

In one embodiment, the motor vehicle comprises a cable for charging the battery of the electric motor vehicle, the cable being positioned in a recess which is underneath the front hood of the vehicle.

The invention also relates to a method for unlocking a front hood of a motor vehicle according to the invention, comprising a step of pulling on the grip means of the arrangement, the grip means being outside the passenger compartment.

The invention furthermore relates to a method for charging an electric motor vehicle according to the invention, comprising the following steps:
a step of opening a charging port of the vehicle,
a step of pulling the grip means of the arrangement to unlock a front hood of the vehicle, the grip means being positioned inside the charging port,
a step of grasping a charging cable in a recess which is underneath the front hood of the vehicle,
a step of connecting an electric vehicle charging terminal to a charging interface of the port via the charging cable, and
a step of locking the grip means while the vehicle is charging, all the steps of the method being executed outside the passenger compartment of the motor vehicle.

The appended drawing shows, by way of example, one embodiment of an unlocking arrangement according to the invention and one embodiment of an unlocking method according to the invention.

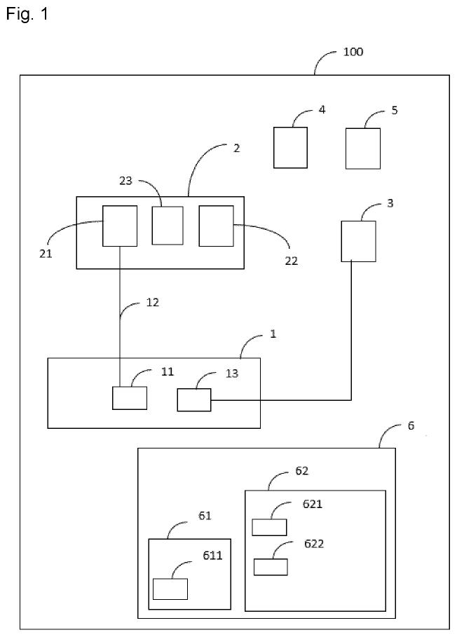

FIG. 1 shows a vehicle equipped with an unlocking arrangement according to the invention.

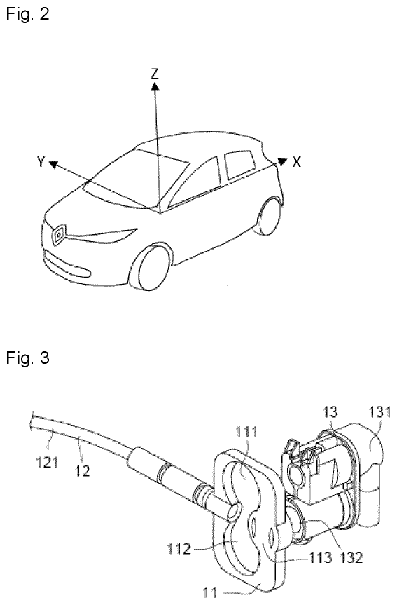

FIG. 2 defines an orthonormal reference system for the motor vehicle.

FIG. 3 is a first perspective view of an unlocking arrangement according to a first embodiment of the invention.

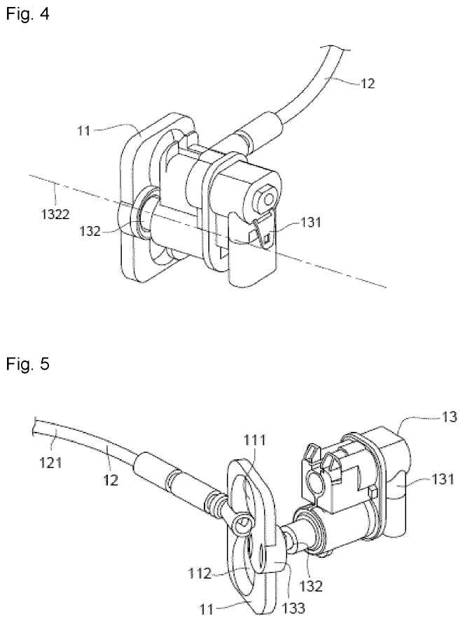

FIG. 4 is a second perspective view of an unlocking arrangement according to the first embodiment of the invention.

FIG. 5 is a third perspective view of an unlocking arrangement according to the first embodiment of the invention.

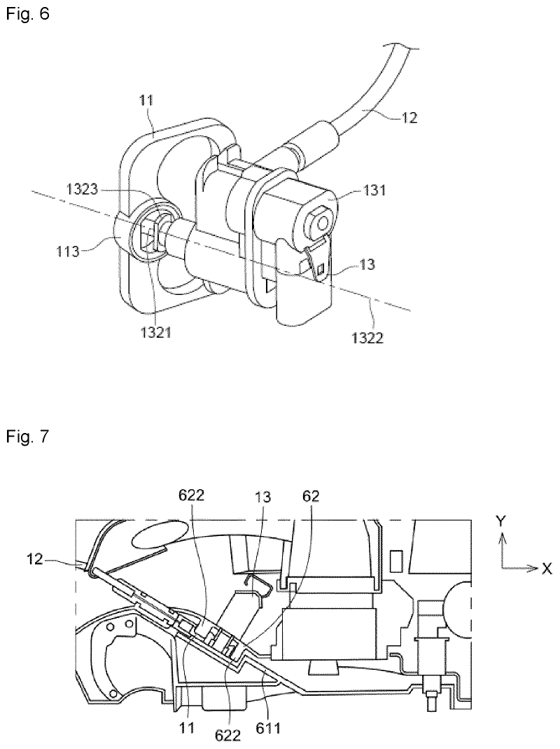

FIG. 6 is a fourth perspective view of an unlocking arrangement according to a first embodiment of the invention.

FIG. 7 is a first sectional view of a charging port equipped with an unlocking arrangement according to the first embodiment of the invention.

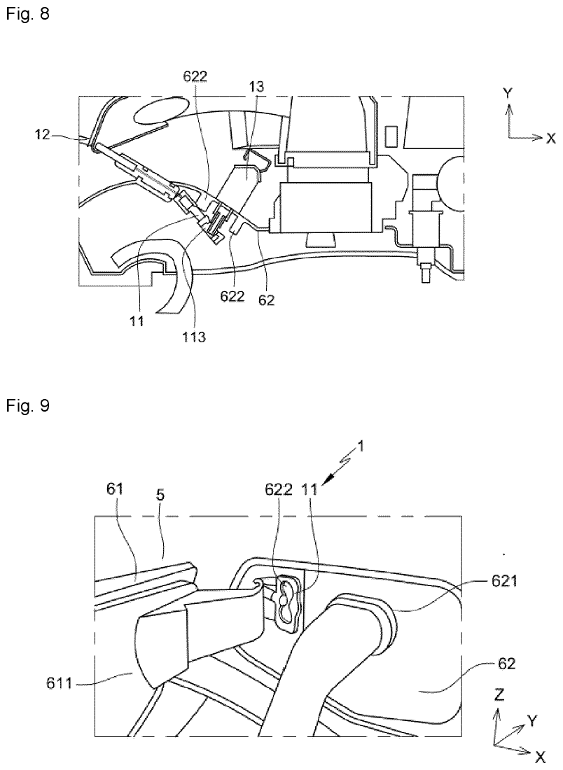

FIG. 8 is a second sectional view of a charging port equipped with an unlocking arrangement according to the first embodiment of the invention.

FIG. 9 is a first perspective view of a charging port equipped with an unlocking arrangement according to the first embodiment of the invention.

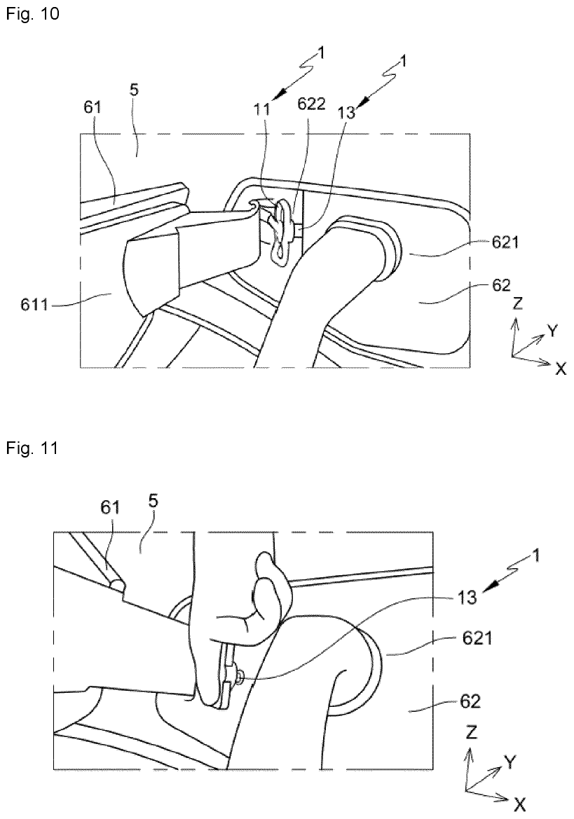

FIG. 10 is a second perspective view of a charging port equipped with an unlocking arrangement according to the first embodiment of the invention.

FIG. 11 is a third perspective view of a charging port equipped with an unlocking arrangement according to the first embodiment of the invention.

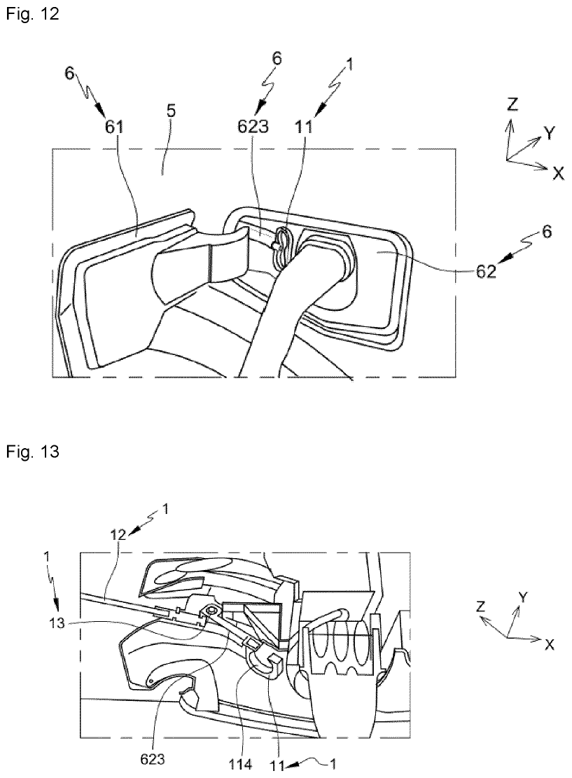

FIG. 12 is a first perspective view of a charging port equipped with an unlocking arrangement according to a second embodiment of the invention.

FIG. 13 is a first sectional view of a charging port equipped with an unlocking arrangement according to the second embodiment of the invention.

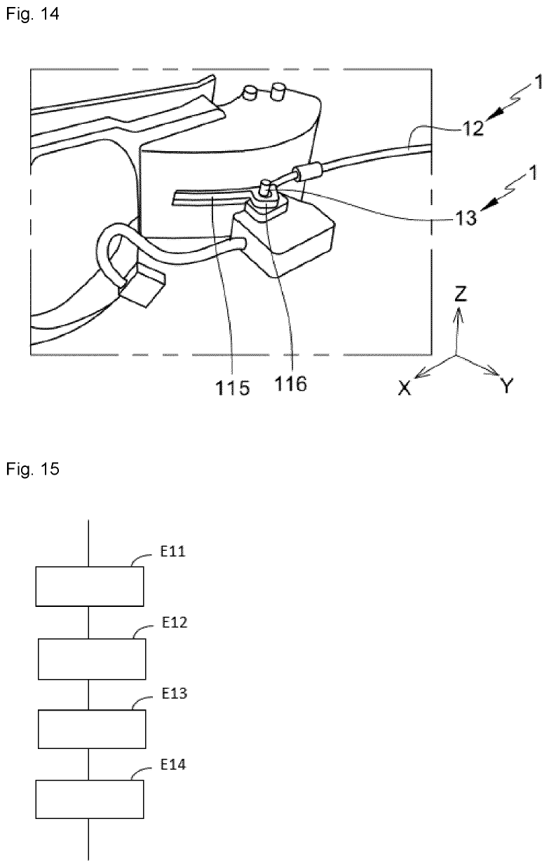

FIG. 14 is a second perspective view of a charging port equipped with an unlocking arrangement according to the second embodiment of the invention.

FIG. 15 is a flowchart of a method for unlocking a front hood according to the invention.

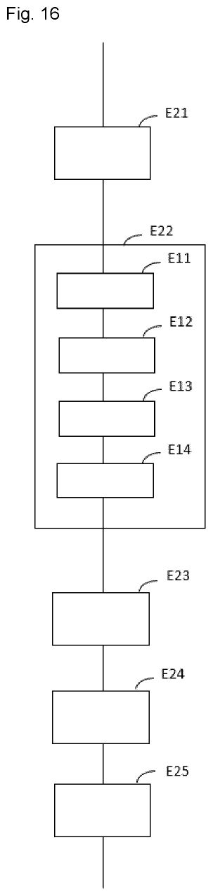

FIG. 16 is a flowchart of a method for charging an electric vehicle according to the invention.

An example of a vehicle 100 equipped with one embodiment of an arrangement for unlocking a front hood is described below with reference to FIG. 1.

The motor vehicle 100 is a motor vehicle of any type, in particular a passenger vehicle or a utility vehicle. The motor vehicle 100 may be equipped with a combustion engine and/or electric motor.

In the remainder of the document, the figures are defined with reference to a direct orthonormal reference system (X, Y, Z) shown in FIG. 2, with the axis X being parallel to the longitudinal axis of the motor vehicle 100 and oriented toward the rear of the motor vehicle 100, and the axis Z being vertical and oriented toward the top of the vehicle.

The motor vehicle 100 comprises a passenger compartment 4 and a front hood 2. The front hood comprises at least one lock 21 which secures the opening of the hood 2. The lock 21 is connected to an arrangement 1 for unlocking the lock 21.

In one embodiment, the motor vehicle 100 may comprise a fitting that can serve as a storage compartment 23, notably for storing cables for connecting the vehicle to a charging terminal.

The arrangement 1 comprises a grip means 11 and a cable 12 connecting the lock 21 to the grip means 11. The grip means 11 is accessible to a user from outside the passenger compartment 4 and no portion of the cable is in the passenger compartment 4 of the vehicle 100. As a result, the cable is integrally positioned outside the passenger compartment 4.

In one embodiment, the grip means is at the front hood 2 or in an area close to the front hood 2 of the vehicle, notably at a front fender 5 or a front bumper or a front grille.

The arrangement 1 and the lock 21 collaborate such that a pulling force exerted by a user on the cable 12 via the grip means 11 unlocks the lock 21

Thus, after having exerted a pulling force on the grip means, the user moves toward the front hood 2, which is in the vicinity of the grip means 11. In one embodiment of the front hood 2, the user can then open the front hood 2 directly. As an alternative, the hood 2 may, for example, additionally comprise a catch 22. In this case, when the lock 21 is unlocked, the hood partially opens. To fully open the front hood 2, the user must then unlock the catch 22 by putting their hand into the opening of the hood.

A first embodiment of an arrangement 1 is shown in FIGS. 3 to 6. In this embodiment, the grip means 11 comprises two cutouts or rings 111, 112 respectively for the passage of two fingers of a user's hand. The grip means 11 can also be described as a handle or pull-bar having a hole, notably omega shaped, for the passage of optimally two fingers of a user's hand.

The grip means 11 is connected to the cable 12 which is hidden by its sheath 121.

The arrangement 1 advantageously comprises a security element 13 intended to prevent unauthorized use of the grip means 11.

In the remainder of the document,
the security element 13 is referred to as “disengaged” when it allows the use of the grip means 11; and
the security element is referred to as “engaged” when it prevents the use of the grip means 11.

A first embodiment of the security element 13 is shown in FIGS. 3 to 6. The security element comprises a fixed part 131 and a movable part 132.

The fixed part 131 is fixed to a fixed and rigid structure of the motor vehicle. In FIG. 7, the security element 13 is shown on the inner side of the charging port. According to an embodiment variant which is not shown, it could be fixed to a vehicle-body structural part that is adjacent to the charging port 6. The fixed part 131 contains the mechanism which controls the movable part 132.

The movable part 132 comprises a pin 1321 which is retractable in a first direction 1322. The movable part 132 also comprises two fins 1323 which are diametrically opposite with respect to the retractable pin 1321 and can rotate about the direction 1322.

This mechanism is usually referred to as “push-pull mechanism”. Under the effect of a pressure on the end of the movable part 132, the retractable pin pulls back and pivots, causing the fins to rotate by 90 degrees. When the pressure is released, the pin 1321 extends.

The movable part 132 is intended to collaborate with a fitting 113 provided in the grip means 11, such that together they form a connecting means between the security element 13 and the grip means 11. The fitting 113 provides a female component of the connecting means and the movable part 132 provides a male component of the connecting means.

When the security element 13 is engaged, as illustrated in FIGS. 3 and 4, the pin 1321 is kept pulled back and the fins 1323 are locked in the fitting 113 of the grip means 11. The grip means 11 is therefore fixed to the security element 13, which is itself fixed to a fixed and rigid structure of the motor vehicle. As a result, when the security element 13 is engaged, it is impossible to use the grip means to apply a pulling force to the cable 12.

Conversely, when the security element 13 is disengaged, as illustrated in FIGS. 5 and 6, when the user presses on the end of the retractable pin, the fins 1323 rotate by 90 degrees, and this allows them to come out of the fitting 113. In addition, the pin 1321 deploys, thus creating a space between the grip means 11 and the security element 13. A user can then grasp the grip means more easily.

FIGS. 7 and 8 illustrate the case in which the security element 13 is fixed to an inner wall 62 of a charging port 6 of an electric vehicle.

In FIG. 7, the security element 13 holds the grip means 11 against the inner wall 62, which is to say in a retracted position. It should be noted that the situation illustrated can correspond
to an engagement of the security element 13, in which case a pressure on the security element 13 via the grip means 11 will not release the grip means 11, or
to a disengagement of the security element 13, in which case a pressure on the security element 13 via the grip means 11 will release the grip means 11.

In FIG. 8, the security element 13 holds the grip means 11 away from the inner wall 62, which is to say in a deployed position. The security element 13 is then disengaged.

In a preferred embodiment, the motor vehicle additionally comprises a vehicle-user authenticating means 3 which controls the security element 13, such that
if a user of the vehicle is authenticated in the vicinity of the vehicle, the security element 13 is disengaged,
otherwise the security element 13 is engaged.

As a result, the grip means 11 can be used only when a person in the vicinity of the vehicle is recognized by the authentication means 3 as being a user of the vehicle.

The user authentication means 3 can for example recognize a magnetic card or key, more generally any item for identifying a person, enabling automatic unlocking of the vehicle when a user is within a given perimeter around the vehicle 100, for example less than two meters from the vehicle. In this embodiment, the authentication means could allow the use of the grip means only when the opening leaves of the vehicle are unlocked.

Other embodiments of the authentication means 3 are conceivable.

In an advantageous embodiment, the vehicle 100 is an electric vehicle and the grip means 11 is disposed inside a charging port 6 of the vehicle 100.

A first embodiment of an assembly 1 comprising a grip means 11 arranged in a charging port 6 is described below with reference to FIGS. 7 to 11. In this embodiment, the assembly 1 comprises a security element 13 as shown in FIGS. 3 to 6.

The port 6 comprises a flap 61 having an inner lining 611. The port 6 additionally comprises an inner wall 62 or bowl 62. The bowl 62 is a rigid wall supporting notably an electrical charging plug interface 621. The bowl 62 delimits a boundary between the engine/motor area of the vehicle and the inside of the charging port 6.

The sheath 121 of the cable 12 is fixed to the bowl 62. In the embodiment described, the assembly 1 makes it possible, by pulling on the grip means 11, to deflect the cable 12 by 20 millimeters in its sheath 121.

The security element 13 is mounted integrally with the bowl 62. As illustrated in FIGS. 7 and 8, the security element 13 passes through the bowl 62, such that the fixed part 131 of the security element 13 is in the engine/motor area, and the movable part 132 of the security element 13 is inside the charging port.

The grip means 11 is disposed such that the recess 113 can collaborate with the movable part 132 of the security element 13.

The bowl 62 also comprises a counter-form 622 of the grip means 11. The counter-form 622, which is shown more particularly in FIGS. 7 and 8, is designed to encase the grip means 11 when the latter is locked by the security element 13, which is to say when the authentication means 3 has not detected a user of the vehicle in the vicinity of the vehicle. In these same circumstances, the counter-form also encases the end of the security element 13.

When the flap 61 of the port remains open for charging the vehicle, and when the user of the vehicle is absent, the unlocking means 11 and the security element 13 must be protected from fraudulent users. As illustrated in FIG. 9, protection is provided by the counter-form 622. This is because the presence of the counter-form 622 makes it very hard to destroy the security element 13 and impossible for a user to put their fingers into the openings of the grip means 11.

In the first embodiment, the inner lining 611 of the port 6 has been defined so as to bring the grip means 11 into a retracted position when the user closes the charging port 6 of the motor vehicle 100. In other words, if the user forgets to put the grip means 11 back into the retracted position before closing the charging port 6, the lining will mechanically exert a pressure on the security element 13 via the grip means 11 as the port is closed.

A second embodiment of an assembly 1 comprising a grip means 11 arranged in a charging port 6 is described below with reference to FIGS. 12 to 14.

In this embodiment, the security element 13 is entirely behind the bowl of the port 6, and this protects it from any deliberate damage when an attempt is made to use the grip means 11 illicitly.

The security element 13 comprises a mechanical finger 135 which is deployed when the security element 13 is engaged and retracted when the security element 13 is disengaged.

The grip means 11 is arranged to as to pass through the bowl of the port 6. The grip means therefore comprises an outer part 114 situated in the space delimited by the port 6, and an inner part 115 situated behind the bowl of the port 6. During use, the grip means slides along a guide 623 provided in the bowl 62. The amplitude of the movement of the grip means 11 in the guide 623 corresponds to the deflection of the cable 12 in its sheath 121, i.e. for example an amplitude of 20 millimeters.

The inner part 115 of the grip means 11 comprises an opening 116 for the passage of the mechanical finger 135 of the security element 13.

The tension exerted by the cable 12 systematically brings the grip means 11 into abutment against the entrance of the guide 623. As a result, as soon as the user releases the grip means 11, the opening 116 is repositioned facing the mechanical finger 135. After use, the grip means 11 is thus automatically repositioned so as to allow activation of the security element 13.

One embodiment of a method for unlocking a front hood 2 of a motor vehicle 100 comprising an arrangement 1 according to the invention is described below with reference to FIG. 15.

The method comprises an unlocking step E13 in which the user exerts a pulling force on the grip means 11 of the arrangement 1, the grip means 11 being outside the passenger compartment 4.

To be able to exert a pulling force, the user must, in a first substep E11, disengage the security element 13 of the arrangement 1. In one embodiment, the disengagement is effected by virtue of a magnetic fob or a magnetic key which can be the key or the fob, more generally any identifying item, used to unlock the vehicle.

Then, if the arrangement 1 has been realized according to the first embodiment, that is to say with a mechanism of the “push-pull” type, the user must, in a second substep E12, exert a pressure on the grip means 11, so as to release it from its recess. If the arrangement 1 has been realized according to the second embodiment, substep E12 is not necessary because the grip means 11 is directly accessible.

Then, in a third substep E13, the user exerts a pulling force on the grip means 11 such that the cable 12 of the arrangement 1 moves in translation. In one embodiment, the deflection of the cable 12 is around several centimeters, for example two centimeters. The tension exerted by the cable 12 on the grip means 13 automatically brings the grip means 11 back into the position it was occupying before the pulling force was exerted. The lock 21 of the front hood 2 is then unlocked.

Then, if the arrangement 1 has been realized according to the first embodiment, in a fourth substep E14 the user exerts a pressure on the grip means 11, so as to put it back into its recess. In a variant, the grip means 11 could be put back into its recess mechanically, for example when a port containing the grip means 11 is being closed. An inner lining of the flap of the port could advantageously be designed to exert a pressure on the grip means 11 so as to put it back into its recess.

If the arrangement 1 has been realized according to the second embodiment, the fourth substep is not necessary.

One embodiment of a method for charging an electric motor vehicle 100 according to the invention is described below with reference to FIG. 16.

In a first step E21, the user opens the charging port 6 of the motor vehicle 100. In one embodiment, the opening of the port 6 is secured by a means for authenticating the user, using, for example, a magnetic fob or a magnetic key.

In a second step E22, the user exerts a pulling force on the grip means 11 of the arrangement 1 to unlock a front hood 2 of the vehicle.

The second step E22 is broken down into four substeps E11 to E14, which were described above in the embodiment of the method for unlocking a front hood. It should be noted that the substep E11 of disengaging the security element 13 can advantageously be performed by the same means as the unlocking of the port 6 performed in the step E21. In other words, it is the same magnetic fob or the same magnetic key, more generally any identifying item, which makes it possible to unlock the port 6 and disengage the security element 13. At the end of step E22, the lock 21 of the front hood 2 is unlocked.

In a third step E23, the user grasps a charging cable in a recess 23 which is underneath the front hood 2 of the vehicle. For this, the user moves from the port 6 toward the front hood 2 of the vehicle. They then open the front hood 2 (which was unlocked beforehand during step E22) in order to grasp the cable and close the front hood 2 again.

In a fourth step E24, the user connects an electric vehicle charging terminal to a charging interface 621 of the port 6 via the charging cable.

In a fifth step E25, the grip means 11 is blocked while the vehicle is charging. During this step, the user can move away from their vehicle while the port 6 remains open for charging the vehicle. When the user moves away from their vehicle, the authentication means 3 detects the absence of the user and automatically locks the vehicle. In a preferred embodiment, the authentication means 3 also engages the security element 13 of the arrangement, such that the grip means 11 cannot be used to unlock the front hood of the vehicle while it is charging.

Finally, the arrangement 1 according to the invention makes it possible to install a front hood unlocking system outside the passenger compartment 2. Such an arrangement thus avoids the need for a user who has already exited the vehicle to return to the passenger compartment to activate a hood opening mechanism.

As a result, a user who has exited their vehicle, for example to manipulate a charging terminal, does not need to return to the passenger compartment of the vehicle to collect charging cables stored underneath the front hood of the vehicle.

Advantageously, the arrangement 1 can be installed in an electrical charging port, and this reduces the number of movements the user has to make around their vehicle while the vehicle is charging.

If the arrangement 1 is installed in the vicinity of the front hood, the invention additionally makes it possible to reduce the length of the cable connecting the hood lock to the cable pulling lever, and also to reduce the length of the sheath of this cable. A smaller cable makes it possible to have a better effect on the unlocking, since the cable tension can be lower and the cable travel can be shorter.

The embodiments of the arrangement 1 furthermore make it possible to secure access to the engine/motor compartment. In particular, the invention prevents attempts to fraudulently use the arrangement 1.

Furthermore, the cost of implementing the invention is limited. This is because the invention modifies neither the technical features nor the design of the front hood 2 and of the lock 21. Furthermore, the proposed solution reuses mechanisms that are already present on the vehicle, notably in the first embodiment of the arrangement 1, where the “push-pull” system used as security element 13 is the same as the “push-pull” system used to secure the flap of the port 6. The same applies to the locking system of the second embodiment, which is a security element that can also be used to secure the connection of the plug to the charging interface 621 while the vehicle is charging.

In addition, the assembly of the vehicle can be simplified. This is because the arrangement 1 can be advantageously disposed such that the cable does not pass through the passenger compartment. In other words, there is no longer a need to extend a cable between a dry area and a humid area, passing through the dashboard of the vehicle.

1-10. (canceled)

11. A motor vehicle, comprising:
an arrangement for unlocking a lock of a front hood, the arrangement comprising a grip means and a cable connecting the lock of the front hood to the grip means,
wherein the grip means is accessible to a user from outside a passenger compartment of the motor vehicle and at the cable is positioned outside the passenger compartment the motor vehicle.

12. The motor vehicle as claimed in claim 11, wherein the grip means is at the front hood or at a front fender or a front bumper or a front grille.

13. The motor vehicle as claimed in claim 11, further comprising a security element configured to prevent an unauthorized person from using the grip means.

14. The motor vehicle as claimed in claim 13, wherein said arrangement comprises an authentication means which collaborates with the security element such that the grip means can be used only when an item for identifying a user is authenticated by the authentication means.

15. The motor vehicle as claimed in claim 11, wherein the motor vehicle is an electric vehicle and the grip means is disposed inside a charging port of the electric vehicle.

16. The motor vehicle as claimed in claim 15, wherein said arrangement comprises an authentication means which collaborates with the security element such that the grip means can be used only when an item for identifying a user is authenticated by the authentication means, and the authentication means interacts with a device for locking the charging port of the motor vehicle such that the authentication means is configured to unlock the charging port after the identifying item has been authenticated.

17. The motor vehicle as claimed in claim 14, further comprising an identifying item configured to interact with a device for locking the motor vehicle to allow or not allow access to the passenger compartment of the motor vehicle, and the identifying item is configured to interact with the authentication means of said arrangement to unlock the lock of the front hood and/or of a device for locking the charging port of the motor vehicle.

18. The motor vehicle as claimed in claim 15, further comprising a cable configured to charge the battery of the electric motor vehicle, the cable being positioned in a recess which is underneath the front hood of the vehicle.

19. The motor vehicle as claimed in claim 16, further comprising a cable configured to charge the battery of the electric motor vehicle, the cable being positioned in a recess which is underneath the front hood of the vehicle.

20. A method for unlocking the front hood of the motor vehicle as claimed in claim 11, comprising:
pulling on the grip means of the arrangement, the grip means being outside the passenger compartment.

21. A method for charging the motor vehicle as claimed in claim 15, comprising:
opening the charging port of the vehicle;
pulling the grip means of the arrangement to unlock the front hood of the vehicle, the grip means being positioned inside the charging port;
grasping a charging cable in a recess which is underneath the front hood of the vehicle;
connecting an electric vehicle charging terminal to a charging interface of the port via the charging cable; and
locking the grip means while the vehicle is charging.
wherein all steps of the method are executed outside the passenger compartment of the motor vehicle.
